(19) United States
(12) Patent Application Publication
(10) Pub. No.: US 2011/0267454 A1
(43) Pub. Date: Nov. 3, 2011

(54) METHOD AND A DEVICE FOR DETECTING CRACKS IN AN OBJECT

(76) Inventor: Per Henrikson, Trollhattan (SE)

(21) Appl. No.: 11/719,764

(22) PCT Filed: Dec. 16, 2004
(86) PCT No.: PCT/SE04/01910

§ 371 Date: May 21, 2007

(51) Int. Cl. H04N 7/18

(52) U.S. Cl. 348/131; 348/E07.085

(57) ABSTRACT

A method for detecting cracks in an object includes treating an object with a fluorescent agent, illuminating the object, and recording fluorescence from the illuminated object by means of an image-recording unit. An image of the object obtained by means of the image-recording unit is digitized and analyzed automatically with regard to the color content in the image in order to detect any cracks in the object.

### BACKGROUND AND SUMMARY

The present invention relates to a method for detecting cracks in an object, comprising an object being treated with a fluorescent agent, the object being illuminated and the fluorescence from the illuminated object being recorded using an image-recording unit and, in addition, the invention relates to a device for detecting cracks in an object.

A type of non-destructive testing for detecting cracks in objects is so-called penetrant inspection. In such tests, a penetrant, preferably in the form of a liquid, is applied onto the object that is to be investigated. The penetrant liquid enters into small pores and cracks in the object by capillary action. After the removal of superfluous penetrant liquid, drying and developing so that liquid remaining in the cracks is drawn up to the surface of the object, the object is illuminated in order to produce a radiation that can be analyzed, which radiation is unique to the penetrant that has been used. There are principally two different types of method; the object is either illuminated with white light within the visible wavelength range and the object can be analyzed as a result of the reflected radiation from any penetrant that remains in cracks in the object differing from reflected radiation originating from the object itself, or else the object is illuminated with a radiation that means that, unlike the object itself, any remaining penetrant emits fluorescence which can be analyzed.

In the latter case, ultraviolet radiation is normally used to illuminate the object, and an operator inspects the object by eye in order to detect any cracks. In certain cases, in order to facilitate the detection of cracks, a color video camera is also used with an associated monitor, for example for internal inspections in an object, where it would otherwise be difficult or impossible for the operator to study the object by eye. The operator can thus view the object in a corresponding way by studying an image of the object on the monitor and searching for fluorescent indications in the object. On the monitor, the image of the object will appear either in monochrome, so-called greyscale, or in color, depending upon whether the camera and the monitor are of monochrome or color type. Fluorescence from penetrant that remains in the cracks will appear with a different (higher) intensity than the rest of the object.

Even with the use of a color video camera and monitor, this method means that viewing and evaluation are carried out essentially manually. This, in turn, means that the result of the investigation is dependent upon the operator's ability to detect and analyze indications. This work is made considerably more difficult due to the fact that the image can have a high level of noise, that is the image can contain background light of relatively high intensity, or can contain stray light, reflections, false indications caused by dust particles, etc. With the use of an intensity-based greyscale, the possibilities of distinguishing a false indication with high light intensity from an actual crack indication are very limited.

For certain physical configurations it is not possible to carry out a fluorescent penetrant inspection at all, due to the fact that there is insufficient room for the illuminating and image-recording equipment. Examples of such products are coils of piping that are to be inspected internally in order to check, for example, welded joints. In these cases, inspection of the product must be carried out by some alternative method, such as the use of X-ray equipment.

It is desirable to provide a method of the type defined in the introduction that reduces to a significant extent at least some of the disadvantages associated with previously-known such methods.

By automatically digitizing and analyzing an image of the object obtained by means of the image-recording unit with regard to the color content in the image, in order to detect any cracks in the object, the detectablility of cracks can be increased considerably. It has been found that, using the method according to the invention, a level of detectability or resolution for fluorescent indications can be achieved that, in most cases, exceeds an operator's average ability to detect cracks by studying an intensity-based greyscale by eye, and that, at least in certain cases, exceeds an operator's ability to detect cracks by studying a color image on a TV-monitor.

This involves an improved method that is more able to be repeated and that also makes possible automation of fluorescent penetrant testing. The method makes possible automation of penetrant testing as a result of the improved detectability and as a result of the method being less dependent upon an operator manually detecting any cracks in an object that is being tested. Due to the analysis being carried out on the basis of the real color content in the image, the analysis method is less sensitive to the intensity or luminance in the image. In addition, the higher resolution enables the size and shape of an indication to be measured more precisely, for example, in order to evaluate whether it is a false or real indication that has been found.

It is desirable to provide a device of the type defined in the introduction that reduces to a significant extent at least some of the disadvantages associated with previously-known such devices.

A first bandpass filter arranged in the image-recording unit, which bandpass filter lets through radiation in a limited wavelength range that includes a wavelength that lies within the wavelength range in which the object emits fluorescence, means that unwanted radiation with relatively short wavelength and radiation with relatively long wavelength, compared to the wavelengths for the fluorescent radiation, can be cut out. It means that the image obtained by means of the image-recording unit will be based on a higher proportion of radiation with wavelengths in the fluorescence wavelength range that is of interest, or expressed another way: the signal/noise-ratio (S/N) for the image can be increased, which makes it possible to have a higher degree of automation in the detection method. Manual inspection is also made easier. For example, certain false indications from foreign particles that fluoresce in a different wavelength range (such as red) can be blocked by the system, so that the operator does not need to take such indications into account.

It is advantageous if the radiation that originates from the source of illumination, that is direct radiation or reflected radiation, can be blocked by the first bandpass filter in the event of the image-recording unit being sensitive to the radiation in question. This is the case in the event of the use of, for example, a CCD camera and a source of UV radiation to produce fluorescence. In the event of the CCD camera being subjected to extensive UV radiation, the noise level increases and the image can be saturated by the background radiation so that the image is more difficult to analyze with regard to fluorescent indications.

According to a preferred embodiment of the device according to the invention, the device comprises a second bandpass filter arranged in the source of illumination, which bandpass filter lets through radiation in a limited wavelength range that includes ultraviolet radiation. For example, the second bandpass filter can be designed to block any visible light from the source of illumination, such as an UV source, in order to prevent the reflection of such light from reaching the image-recording unit and causing a background level in the image. By the use of a device that utilizes a first bandpass filter in front of the image-recording unit and a second bandpass filter in front of the source of illumination, a very high S/N-value in the image can be achieved that means in practice that the image is essentially completely black except in the areas where there is fluorescence.

It is desirable to provide an arrangement for detecting cracks in an object, comprising a source of illumination for illuminating an object and an image-recording unit for recording fluorescence from the illuminated object, which arrangement makes easier the inspection of objects with a complicated physical configuration.

The use of a deflecting device in the form of, for example, a reflector for deflecting at least a significant quantity of the radiation from the source of illumination in order to illuminate a concealed surface in the object and/or a reflector for deflecting at least a quantity of fluorescence that is sufficient for analysis emitted from a concealed surface in the object to the image-recording unit, provides a method for detecting cracks even in objects with difficult physical configurations. For example, cracks can be detected even in objects that are provided with relatively narrow grooves, such as machined external or internal grooves in cylindrical objects, which grooves would not have been possible to test with a fluorescent penetrant method using conventional equipment due to reasons of space. For example, at least a part of the radiation can be deflected in a direction towards a side wall in such a groove and/or at least a quantity of fluorescence that is sufficient for analysis can be deflected from a side wall in such a groove in a direction towards the image-recording unit. In addition, it is possible to design the arrangement in such a way that one and the same arrangement can be used for testing both the bottom surface and the side wall surfaces in such a groove.

The invention also relates to spectacles for use by an operator for the inspection of fluorescence. The spectacles according to the invention comprise a bandpass filter intended to block radiation with certain wavelengths from reaching the operator's eyes. The bandpass filter can correspond to the abovementioned first bandpass filter in the device according to the invention. By providing an operator with such spectacles, manual detection of cracks can be carried out in a more efficient way. The wavelength range for the radiation with which an object is illuminated can be increased so that the quantity of fluorescence increases. Increased fluorescence results, in turn, in improved detectability. In particular, illumination of the object can be carried out with radiation in the range right up to 450 run, for example in the range 320-450 nm, so that visible light in the range 380-450 is also utilized to create fluorescence. As these wavelengths correspond to radiation within the visible range, illumination with such radiation for inspection without the use of the spectacles according to the invention would only make the inspection more difficult. As a result of excluding radiation, for example, from and including UV light and up to approximately 450 nm, by means of a suitably designed bandpass filter range, the operator does not receive the visible light that is used for illumination of the object, so that this light does not interfere with the inspection.

Other advantageous characteristics and functions of different embodiments of the invention are apparent from the following description and subordinate claims.

It should, however, be emphasized that the aspects of the present invention described above can be utilized individually or as a combination comprising two or more of the aspects. This also means that all the embodiments described in the following description could be combined with each other if so required.

### BRIEF DESCRIPTION OF THE DRAWINGS

A detailed description of exemplary embodiments of the invention is given below, with reference to the attached drawings.

In the drawings:

FIG. 1 shows a perspective view of an HSL color space illustrated as a double cone,

FIG. 2a shows a cross section taken at any position along the longitudinal axis of the double cone in FIG. 1,

FIG. 2b shows the cross section in FIG. 2a provided with lines for dividing the cross section into sectors corresponding to fields with different hues,

FIG. 2c shows the cross section in FIG. 2b provided with an inner circle for dividing fields with different color saturation,

FIG. 3 shows a schematic illustration of a device according to the invention,

FIG. 4 shows a schematic illustration of an arrangement according to the invention,

FIG. 5 shows a schematic illustration of a variant of the arrangement in FIG. 4, and

FIG. 6 shows a pair of spectacles according to the invention.

### DETAILED DESCRIPTION

In digitized color-image processing, one of the color spaces RGB (Red, Green, Blue) or HSL (Hue, Saturation, Luminance) is normally used. By using color spaces, individual colors can be represented. A color space is a space in a three-dimensional coordinate system in which each color is represented by a point.

RGB, that is used within computer technology, thus works with the color components red, green and blue in order to describe an individual color by means of a combination of these. The RGB color space can be visualised as a three-dimensional cube with the vectors R, G and B, all of which can assume any values between 0 and 1.

In the HSL color space, hue, saturation and intensity are used instead to distinguish one color from another. The hues, such as red, orange, yellow, green, blue, violet, etc, can be those that are comprised in the visible color spectrum. By saturation is meant the quantity of white that is added to the hue according to the principle that the less white, the higher the saturation and purity of color. For example, the color red has a higher saturation than the color pink that comprises a mixture of the colors red and white. The intensity is governed by the lightness or darkness of the image.

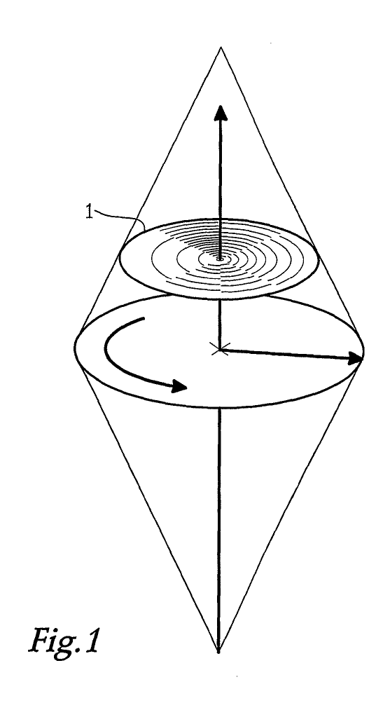

The HSL color space can be illustrated by means of a double cone, see FIG. 1, with a circular cross section where the hues are represented by different positions around the circumference of any cross section through the cone. The hues can thus be expressed as values from 0 to 360°. In addition, the saturation of the color is defined for a given point in a cross section by the distance between the longitudinal axis of the cone and the point in question, that is the radius on which the point is located. The color saturation can assume values between 0 and 1, where the highest value is represented by a point that lies on the peripheral surface of the cone. In addition, the intensity is defined along the longitudinal axis of the double cone from one apex to the other, so that the value varies from 0 (absence of light so that the image is completely black) to 1 (so much light that the image is completely white).

A great advantage of the HSL color space is that the intensity component is separated from the hue component, which means that the color representation is independent of the light intensity, which in turn gives this analysis method a higher tolerance to variations in lighting conditions.

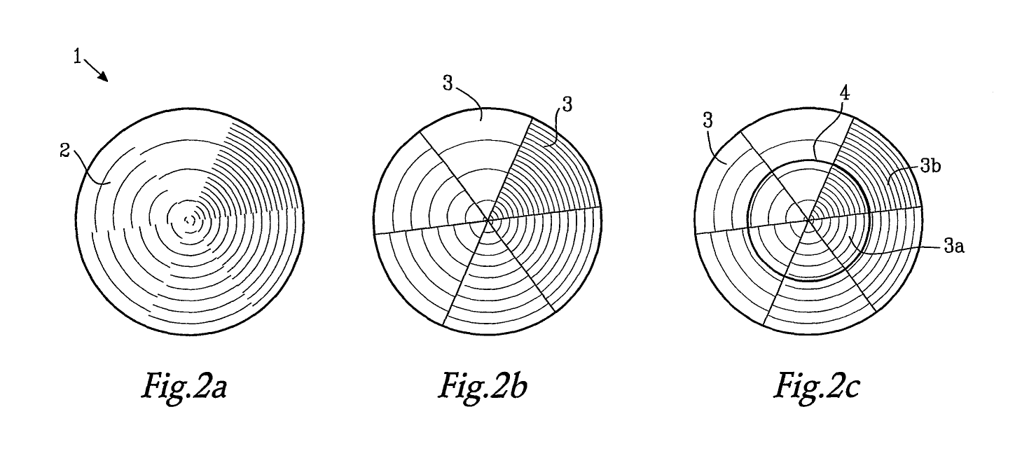

FIGS. 2a, 2b and 2c illustrate an example of how an image can be digitized and represented in the HSL color space. FIG. 2a shows a disk 1 illustrating a color spectrum 2 with different hues (different shaded fields), which disk corresponds to a cross section through the double cone in FIG. 1. In FIG. 2b, the disk is divided into sectors 3 representing different hues. In FIG. 2c, an inner circle 4 divides the sectors 3 into smaller areas 3a, 3b with different color saturation. Each delimited area or element 3a, 3b has thus a different hue and/or color saturation and constitutes a so-called color component. It should be emphasized that the division illustrated in FIG. 2c should only be regarded as an example and that a higher resolution can be obtained by means of a finer division of the elements. The set of elements forms a color component array that can be used for color analysis of an image.

In an aspect of the method according to the invention for detecting cracks in an object, an object is treated with a fluorescent agent. The object is illuminated and fluorescence from the illuminated object is recorded by means of an image-recording unit. An image of the object obtained by means of the image-recording unit is digitized and analyzed automatically, preferably in HSL-format, with regard to the color content in the image in order to detect any cracks in the object. Analyzing of the color content can be carried out in the form of a color spectrum analysis of the recorded image. By this means, the distribution of the color components in a given color spectrum can be studied, and also the size of the individual color components in relative or absolute terms. A color component is preferably represented by a particular hue and a particular color saturation and is represented by (HS) in the HSL color space. In other words, the image is analyzed with regard to at least the hue (H) of the image, preferably with regard to both hue (H) and color saturation (S) represented in the HSL color space in order to reveal any cracks in the object. The intensity (L) in the image can also be used as an analysis parameter in order to reveal any cracks, and/or the shape or extent of cracks in the object. A great advantage of the use of the HSL color space for analysis of the image is that the color representation is separated from the light intensity which, in turn, gives a higher tolerance to variations in lighting conditions under which the penetrant testing is being carried out.

By automatic analysis is meant here an evaluation of the image by the use of a computer and requisite software or corresponding equipment. A computer program that can be loaded directly into the internal memory of a computer, comprising data code or software code elements for instructing a processor, can be used in order to carry out the analysis when the program is run on a computer. It should, however, be pointed out that the result from the analysis can, of course, be used for manual evaluation, and, in addition, the automatic analysis can be supplemented by manual inspection, if so required.

During analysis of an image, the image can be divided into different parts, preferably in accordance with the division of the image into so-called pixels, and the number of such parts that fall within a given element in a color component array can be recorded, calculated and/or saved.

In the current application for analyzing fluorescence with the aim of identifying cracks in various objects, there is, of course, no (or possibly only certain preliminary) advance information regarding the possible position or extent of any cracks. As will be described in greater detail below, the fluorescence from the fluorescent agent that is utilized has, however, a unique spectral signature. This can be used in order to detect cracks in an object by the use of color seeking and a reference.

In an advantageous embodiment of the method according to the invention, the method comprises analyzing the image to detect cracks by means of color seeking. Color seeking can be carried out by comparing the image that is to be analyzed with a reference element by element, for example pixel by pixel, and with regard to color information. The color information from the image that is to be analyzed is compared with the color information from the reference. The color seeking method can be divided into two main stages, namely a first stage in which the reference is created, and a second stage in which the analysis is carried out.

During the first stage, a reference is created by recording, by means of the image-recording unit, a fluorescent indication from the fluorescent agent that is utilized. This can be carried out by illumination of a separate sample of the fluorescent agent concerned or by obtaining an image from the fluorescent agent when this is applied on the object that is illumined and that is intended to be analyzed. From the image that is obtained by means of the image-recording unit, the spectral signature of the fluorescent agent is extracted, which is then used in the subsequent second stage. When the fluorescent agent has a known well-defined fluorescence spectral signature for the radiation with which the object is illuminated, an alternative procedure could be for a reference to be created on the basis of theoretical knowledge instead of practical testing. In such a case, a reference can be created that can then be used directly for the color seeking.

During the analysis, a color spectrum is calculated for the area in the image that is to be analyzed, and this color spectrum is then compared with a reference based on the spectral signature of the fluorescent agent. A value can then be calculated for each area in the image that is being analyzed, which value represents the extent to which the color content in the image matches the spectral signature of the fluorescence. For example, a color spectrum can be calculated for each pixel position in the image, which in turn is compared with the spectral signature extracted from the fluorescent agent indication.

An alternative method for analyzing the digital image is to use so-called color threshold setting. This method, which unlike the color seeking method is dependent upon relatively well-defined background characteristics in the image, involves one or more threshold ranges or threshold values being specified for the color signal. With the use of an RGB color space, R, G and B can thus each be allocated a threshold range, and when an HSL color space is used, H, S and L can be allocated threshold ranges. Note that H represents a spectrum of hues, and that defining a range based on a reference, such as for example 100-160 if H varies between 0 to 255, will result in only color components with hues within that range being considered to match the reference. This range can, however, comprise several hues, and it is also possible to define several discrete ranges. An additional threshold range relating to S, such as for example O-75 if S varies between 0 to 255, means that an additional requirement concerning color saturation, in addition to the hue threshold range, must be fulfilled in order for the color component to match the reference. By defining the threshold range for L as the whole intensity range from black to white, the analysis will be independent of the intensity, that is all color components that fulfil the hue threshold range and the color saturation threshold range are considered to match the reference.

As mentioned above, for the color threshold setting method, relatively well-defined background characteristics in the image are required, which is the case when the image has an essentially constant and known background level. In an embodiment of the device according to the invention that is described below, the aim is to achieve an image that is completely black except for the areas where there is fluorescence. In such a case, the color threshold setting method can be an alternative or a supplement to the color seeking method.

For color threshold setting, the color image is converted to a binary image in such a way that the binary value for the respective color component in a given position, such as a pixel, in the image, is set to 1 if and only if its color component value (R, G or B; or alternatively the color components within the framework for H, S and L) is within the threshold range, and otherwise the binary value is set to 0. Thereafter the binary representation can be analyzed automatically or manually by means of various methods for binary morphology. In addition, measurement of size, circumference, etc, of an indication can be carried out on the basis of the binary representation of the image. A great advantage of color threshold setting is precisely that it provides greater opportunities for analysis and measurement of the extent of indications, while color seeking in general provides information about the position and the number of items found.

It should be pointed out that, although the RGB color space can be used for threshold setting when the background conditions are favourable, experiments have shown that, in general, the HSL color space gives better results. This applies both for manual and for automated evaluation of the result from the automatically analyzed image. In addition, the use of the HSL color space results in threshold setting that is less sensitive to variations in the background level in the image.

It is possible to use both color seeking and color threshold setting in parallel for automatic analysis of images, so that the different advantages of these can be utilized at the same time. In all the cases described above, it is possible with automatic analysis to carry out the analysis of the image in real time, that is in direct association with the recording of the image, and essentially to obtain information straight away about a crack indication that has been found.

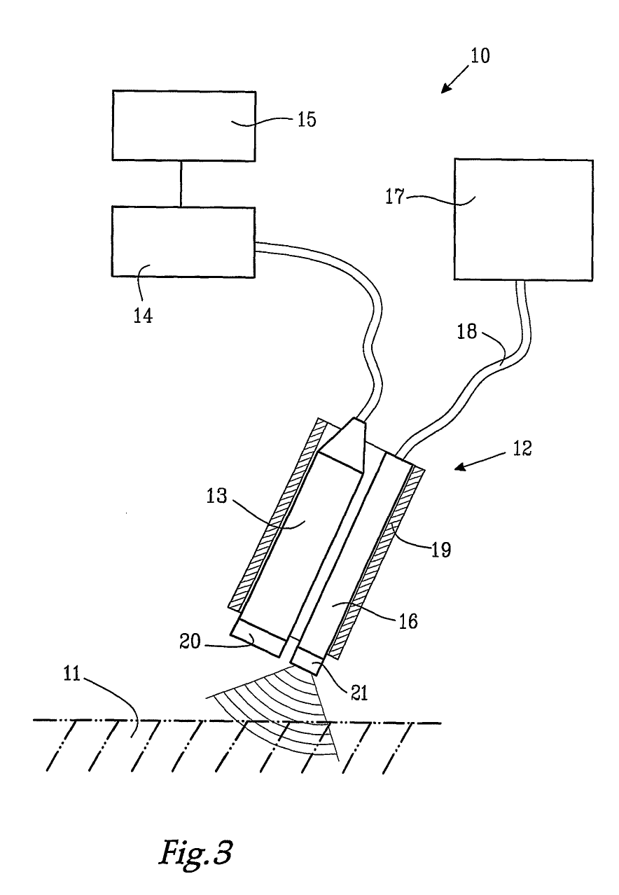

FIG. 3 is a schematic illustration of a device 10 according to the invention for detecting cracks in an object 11. The device 10 has a source of illumination 12 for illumination of the object 11, preferably with mainly ultraviolet radiation, and an image-recording unit 13 for recording fluorescence from the illuminated object 11.

The image-recording unit 13 can be a camera, suitably a color video camera, and preferably a CCD camera. The image-recording unit 13 comprises an image-processing unit 14 or is connected to an image-processing unit. The image-processing unit 14 suitably includes a computer and associated software. A computer program that can be loaded directly into the internal memory of the computer, comprising data code or software code elements for instructing a processor, can be used to digitize and automatically analyze the recorded images. A display unit 15, such as a TV monitor, can be connected to the computer in order to show the automatic analysis and/or in order to enable an analysis also be carried out manually as a supplement to the analysis that has been carried out automatically. It should be pointed out that different color spaces can be used for carrying out the automatic analysis on the one hand and for displaying the result of the analysis on the other hand. For displaying the result on, for example, a TV monitor 15, an RGB representation of the displayed colors is normally used, while, as described above, the actual analysis of the image recorded from the object 11 is advantageously carried out with the colors represented in an HSL color space.

The source of illumination 12 can comprise an outlet 16 or the like for directing and dispersing the radiation to the required position on an object. In the example illustrated, the source of illumination 12 comprises a source of radiation 17, such as a mercury vapour lamp, an optical conductor 18, and the said outlet 16 connected to the source of radiation 17 via the optical conductor 18.

In addition, the image-recording unit 13 and the outlet 16 of the source of illumination can be combined so that these can be directed towards essentially the same area in the object that is to be tested. The image-recording unit and the source of illumination can, in addition, be arranged on some form of traversing device so that they can be moved in relation to the object by commands from an operator and/or from a computer-based control unit. In the embodiment illustrated, the image-recording unit 13 and the outlet 16 of the source of illumination are arranged in a common holder 19 or bracket.

A first bandpass filter 20 is arranged in the image-recording unit 13 to cut out radiation of certain wavelengths. The first bandpass filter 20 is suitably arranged in front of the image-recording unit or constitutes a front part of the image-recording unit. The bandpass filter 20 lets through radiation in a limited wavelength range that includes a wavelength that lies within the wavelength range in which the object emits fluorescence, but cuts out undesirable wavelengths. The term bandpass filter is thus to be interpreted in the broadest sense as a means for letting through radiation with particular wavelengths (the bandpass range) while blocking radiation that has other wavelengths (outside the bandpass range). The word “filter” thus refers primarily to the function and it should be pointed out that the bandpass filter 20 can be constructed in many different ways for blocking radiation of a particular wavelength but letting through radiation of a different wavelength. For example, the bandpass filter can be created from one or more optical components.

The wavelength range of the bandpass filter should, of course, be matched to the fluorescence emitted from the fluorescent agent. A fluorescent agent, for example in the form of a liquid-based penetrant, is normally used that emits fluorescence in a wavelength range that includes the wavelength 530 run when illuminated by ultraviolet radiation. The spectral signature of the fluorescence radiation can be such that there is a peak around 530 run, that is a relatively large amount of the fluorescence has a wavelength in the area around 530 nm. For longer and shorter wavelengths, the intensity of the fluorescence radiation decreases. In such cases, the bandpass range of the bandpass filter is preferably arranged so that radiation in a limited wavelength range essentially centered around 530 nm passes through the bandpass filter and reaches the image-recording unit. Although it is often advantageous to use such a wavelength range, for example corresponding essentially to a range from the blue-green area to the yellow-green area, in the bandpass filter, it should be emphasized that, with the use of a different source of illumination and/or a different fluorescent agent that gives rise to fluorescence in a different wavelength range, a bandpass filter is, of course, selected that is adapted for that specific fluorescence.

The wavelength range of the first bandpass filter 20 corresponds preferably to essentially the whole wavelength range in which the object emits fluorescence of significance. The use of such a bandpass filter means that as much relevant radiation as possible can be recorded by the image-recording unit, while at the same time other radiation is cut out. By this means, the most information possible is obtained for image generation based on radiation recorded by the image-recording unit. Which size of bandpass filter is optimal is, however, always a difficult choice, as although a filter with too narrow a bandwidth identifies the fluorescence well, at the same time there is a tendency for the intensity in the recorded image to be too subdued. A filter with too wide a bandwidth provides a high intensity in the image, but there is a tendency for it to be too sensitive to background light and directly-reflected radiation. It is advantageous if radiation that originates from the source of illumination, that is direct radiation or reflected radiation, can be blocked by the first bandpass filter if the image-recording unit is sensitive to the radiation in question. This is the case, for example, with the use of a CCD camera and a UV radiation source to produce the fluorescence. If the UV radiation is not blocked before it reaches the CCD camera, the noise level increases and the image can be saturated by the background radiation so that the image is difficult or impossible to analyze with regard to the fluorescent indications.

In many cases, the upper limit for the wavelength range of the first bandpass filter is in the range 560-600 run, preferably 560-580 nm, and, in many cases, the lower limit for the wavelength range of the first bandpass filter is in the range 450-500 nm, preferably 470-500 nm. The wavelength range of the first bandpass filter is preferably 490-570 nm.

In an advantageous embodiment of the device according to the invention, the device comprises a second bandpass filter 21 arranged in the source of illumination 12, here arranged in front of the outlet 16 of the source of illumination 12. Although, in the embodiment illustrated in FIG. 3, the second bandpass filter 21 is arranged after the optical conductor 18 with regard to the main direction of the radiation from the source of radiation 17, in a second embodiment, the second bandpass filter could be arranged, for example, between the source of radiation 17 and the optical conductor 18, if unwanted wavelengths originate from the source of radiation rather than from the optical conductor. It is, however, an advantage to arrange the second bandpass filter in front of the optical conductor 18. This means that the outgoing radiation is less dependent upon the characteristics of the optical conductor 18. In addition, a relatively broadband source of radiation 17 can be used and a bandpass filter with a different bandpass range can be placed in front of the optical conductor 18, that is after the optical conductor 18 in relation to the main direction of the radiation from the source of radiation 17, in order to obtain a radiation for illumination of the object 11 that has a wavelength that is adapted to the application in question.

The second bandpass filter 21 lets through radiation in a limited wavelength range that includes ultraviolet radiation. The primary object of the second bandpass filter is to ensure that only such radiation that gives rise to the required fluorescence reaches the object, and that the risk of false signals and background noise in the image are minimized.

This means that radiation with a wavelength that does not give rise to the required fluorescence, and that could be recorded by the image-recording unit as fluorescence as a result of direct radiation or reflection, should be blocked to the greatest possible extent. In other words, the wavelength range of the second bandpass filter lies preferably outside the wavelength range in which the object emits fluorescence.

In order to obtain radiation within the UV range that is suitable for illumination of the fluorescent agent, the wavelength range of the second bandpass filter can include the wavelength 365 run, and can preferably be essentially centered around 365 run. The bandpass range of the second bandpass filter is suitably selected so that radiation in a limited wavelength range around 365 nm passes through the bandpass filter and reaches the object.

The wavelength range of the second bandpass filter is suitably adapted to suit the relevant analysis situation.

The analysis situation involving manual analysis by directly studying the object differs from the analysis situation involving manual evaluation by studying a monitor, where either a manual analysis is carried out or where an automatic analysis is displayed for manual evaluation, and a more or less automated analysis.

When a manual direct inspection of the object is to be carried out (separately or in parallel with an evaluation via a monitor), in many cases the upper limit for the wavelength range of the second bandpass filter is in the range 380-410 nm, preferably approximately 400 nm, and in many cases the lower limit for the wavelength range of the second bandpass filter is in the range 300-350 nm, preferably 310-330 nm. With manual direct inspection, the wavelength range of the second bandpass filter is thus preferably 320-400 nm.

Although, in many cases, this wavelength range works well, even for analysis via a monitor and for automatic analysis, in these cases it is possible to increase the wavelength range up to an upper limit in the range 440-470 nm, preferably approximately 450 nm, in order to increase the illumination of the object and thus create more fluorescence. Visible light (which for manual direct inspection would make the inspection more difficult) in the range 400-450 run can be utilized to generate fluorescence. An increased illumination with more energy in turn makes it possible to illuminate larger areas while retaining detectability without moving the source of illumination and/or the object, and, in certain cases, essentially the whole object can be illuminated while retaining detectability and keeping the relative positions of the object and the source of illumination. It should be pointed out that the increased range up to 450 nm can also be used for direct inspection when the operator utilizes the spectacles according to the invention.

By positioning the second bandpass filter 21 in front of the optical conductor 18, the second bandpass filter can be changed for different analysis situations in a simple way. For example, a bandpass filter with the bandpass range 320-400 nm can be used for direct inspection and/or camera inspection, and a bandpass filter with the bandpass range 320-450 nm can be used for camera inspection and/or direct inspection by an operator equipped with spectacles according to the invention.

In a corresponding way as for the first bandpass filter, for the second bandpass filter there is also a difficult choice relating to the selection of the second bandpass range, to achieve a bandpass range that provides a sufficient quantity of radiation for illumination of the object and the creation of the requisite fluorescence while, at the same time, preventing unwanted radiation from reaching the image-recording unit in an effective way.

As described above, it is desirable for the ratio between actual signal and background noise, S/N (signal/noise), to be as large as possible in order to obtain an image that means that the analysis results in cracks, or at least indications of cracks, being able to be detected with relatively high detectability. This, in turn, makes possible automated crack detection. By the use of a device that utilizes a first bandpass filter in front of the image-recording unit and a second bandpass filter in front of the source of illumination, a very high S/N-value can be achieved, which, in practice, means that the image is essentially completely black except in the areas where there is fluorescence.

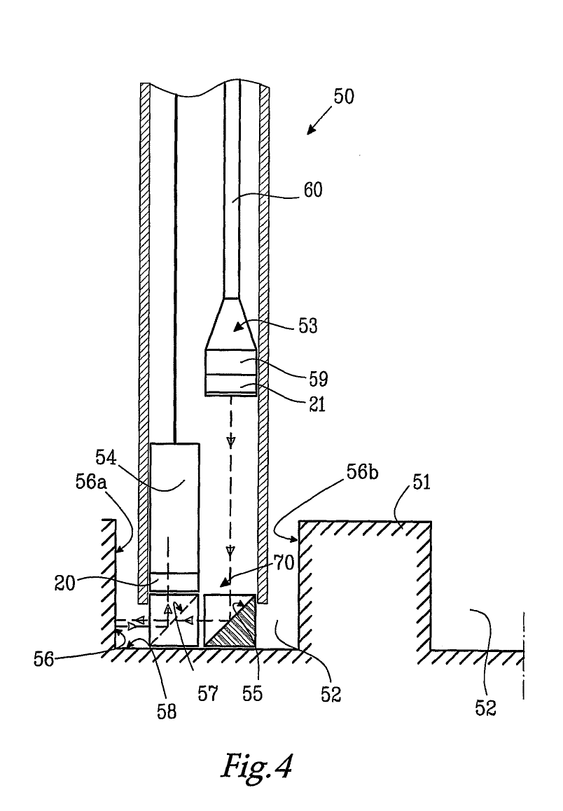

FIG. 4 illustrates an arrangement 50 according to the invention for detecting cracks in an object 51. The object 51, such as a cylinder or the like, can, for example, have external or internal grooves. In the example illustrated, the object has grooves 52 with two side wall surfaces 56a, 56b and a bottom surface 58.

The arrangement comprises a source of illumination 53 provided with an outlet 59 that can have a collimator function, and a source of radiation (not shown) and also an optical conductor 60 that runs between the outlet and the source of radiation. The source of illumination 53 is arranged to illuminate the object 51, for example with ultraviolet radiation, and an image-recording unit 54 is arranged to record fluorescence from the illuminated object 51. The image-recording unit 54 can be a camera, such as a color video camera of, for example, the CCD type. In order to produce the fluorescent indications, the object 51 can be treated with a fluorescent penetrant (as was described above).

The arrangement comprises a device 70 according to the invention for deflecting radiation. In this case, the deflecting device 70 comprises a first reflector 55 arranged to deflect at least a significant quantity of the radiation from the source of illumination 53 to illuminate a concealed surface 56a in the object 51. In the example illustrated in FIG. 4, the first reflector comprises a mirror arranged in a prism for deflecting the radiation through essentially 90° in relation to the main direction of the radiation from the source of illumination 53.

By significant quantity of radiation is meant here as much radiation as is required in order to create the requisite fluorescence and make possible subsequent recording of fluorescence for image generation. Preferably at least 25% of the radiation is deflected, and more preferably at least 50% of the radiation is deflected. It is probable that the arrangement will be more effective the more radiation that is deflected towards the concealed surface so that, in most cases, it is desirable to reflect essentially 100% of the radiation. In certain cases, there can, however, be reasons for designing the first reflector so that a part of the radiation still passes through the reflector without being deflected. By this means, analysis of other areas that are located elsewhere in comparison with the concealed surface in relation to the arrangement could be made possible.

By concealed surface is meant a surface 56a that cannot be illuminated in the required way by the source of illumination 53 by direct radiation, or a surface from which emitted fluorescence cannot be recorded by the image-recording unit 54, as a result of the physical configuration of the object and/or the analysis equipment. In the case illustrated, the external groove 52 on the object 51 is too narrow to enable the source of illumination 53 and the image-recording unit 54 to be arranged in the groove 52 and aimed directly towards the surface 56a in order to carry out the analysis. The groove 52 is also too deep to enable analysis equipment of the conventional type to be positioned outside the object 51 in order to carry out the test. In order still to be able to carry out the analysis of the concealed surface 56a, the first reflector 55 reflects the radiation from the source of illumination in the direction towards the concealed surface 56a.

In the embodiment illustrated, the deflecting device 70 also comprises a second reflector 57 for deflecting at least a quantity of fluorescence emitted from the concealed surface 56a to the image-recording unit 54 that is sufficient for analysis. In the example illustrated in FIG. 4, the second reflector 57 is created in a double prism that acts as a beam splitter in such a way that fluorescence emitted from the concealed surface 56a is divided up at the interface between the two prisms in the double prism so that a part of the fluorescence is deflected in the direction towards the image-recording unit 54. In this case, approximately 50% of the fluorescence that comes from the concealed surface 56a is deflected through essentially 90° in the direction towards the image-recording unit. (The remaining part is deflected in the opposite direction towards the bottom 58 of the groove.) There are, of course, other ways of creating a reflector for the fluorescence so that different quantities of the fluorescence can reach the image-recording unit. At least 25% of the fluorescence is preferably deflected, and more preferably at least 50% of the fluorescence is deflected in the direction towards the image-recording unit. In a second embodiment of the invention, such a second reflector can be used without the first reflector, when the concealed surface can be illuminated directly by the source of illumination, but when the image-recording unit cannot receive directly-radiating fluorescence from the concealed surface. It is thus possible to utilize the first reflector according to the invention and the second reflector according to the invention individually or in combination with each other, as illustrated in FIG. 4.

As described above, it is also possible to combine the arrangement according to the invention with what is described above relating to the method according to the invention and/or the device according to the invention. For example, the said first bandpass filter 20 can thus be arranged in front of the image-recording unit 54 and/or the said second bandpass filter 21 can be arranged in front of the source of illumination 53 in the arrangement according to the invention.

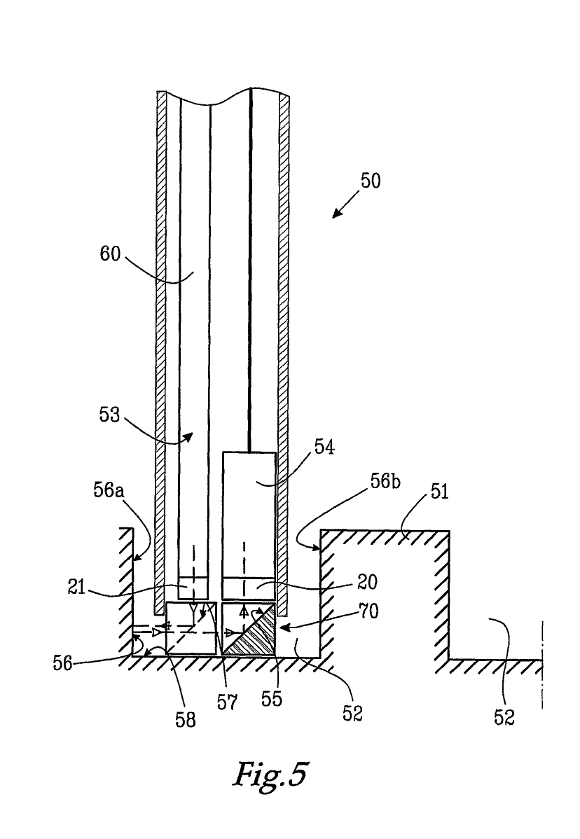

FIG. 5 illustrates a variant of the arrangement according to the invention. In this embodiment, the source of illumination 53 and the image-recording unit 54 are arranged in relation to each other in such a way that the source of illumination 53 is arranged instead closest to the concealed surface 56a that is to be inspected. This means that the risk of radiation from the source of illumination causing interference in the image-recording unit is reduced. In FIG. 4, the radiation will pass the image-recording unit 54 (between the image-recording unit 54 and the bottom surface 58) on its way towards the surface 56a, while in the embodiment in FIG. 5, the radiation is deflected towards the surface 56a without passing the image-recording unit 54. In addition, the optical conductor 60 in FIG. 5 is positioned essentially extremely close to the prism which means that the need for a collimator is reduced as a certain degree of divergence of the radiation from the optical conductor can be permitted when the path of the radiation is relatively short. This, in turn, makes possible the manufacture of a more compact arrangement.

The invention also relates to the use of an arrangement according to the invention for detecting a crack in a groove that has a bottom surface 58 and at least a side wall surface 56a, which crack can be located in the bottom surface or in the side wall surface, or for detecting a crack in a groove that has a bottom surface 58 and two side wall surfaces 56a, 56b, or for detecting a crack in a groove that has a bottom surface and two side wall surfaces, in which groove the side wall surfaces are essentially parallel and extend essentially at right angles in relation to the plane of the bottom surface.

The arrangement according to the invention can, for example, be used as follows:

Inspection of the Bottom Surface of the Groove

The arrangement is rotated in relation to the position illustrated in FIG. 4, so that the radiation deflected from the first reflector 55 is directed towards the bottom surface 58, and so that the image-recording unit 54 and the outlet 59 of the source of illumination 53 “look in the longitudinal direction of the groove 52” parallel with the groove (perpendicular to the plane of the paper in FIG. 4),

the arrangement is positioned in such a way that the part of the bottom surface 58 that is closest to the side wall surface 56a can be scanned, the image-recording unit 54 is positioned at the focusing distance in relation to the bottom surface 58 for recording fluorescent indications on the bottom surface (which in this case constitutes the outer surface of the object that is to be tested),
the object is rotated one revolution while simultaneously inspecting the bottom surface to scan around the whole of the circumference of the object,
the arrangement is moved one step (manually or automatically) towards the second side wall surface 56b, after which the object is rotated in such a way that a second part of the bottom surface 58 can be scanned around the whole circumference of the object, and
this last element is repeated until the whole of the bottom surface 58 has been inspected.

Inspection of a Side Wall Surface in the Object

The image-recording unit is positioned as illustrated in FIG. 4, and in such a way that the part of the side wall surface 56a that is closest to the bottom surface 58 can be scanned, the image-recording unit 54 is positioned at the focusing distance in relation to the side wall surface 56a for recording fluorescent indications on the side wall surface,

the object is rotated one revolution while simultaneously inspecting the side wall surface 56a to scan around the whole of the circumference of the object,
the arrangement is moved one step (manually or automatically) in a radial direction away from the bottom surface 58, after which the object is rotated in such a way that a second part of the side wall surface 56a can be scanned around the whole circumference of the object, and
this last element is repeated until the whole of the side wall surface has been inspected.

Inspection of the Second Side Wall Surface

The inspection is carried out according to the procedure described for the first side wall surface 56a, but with the difference that the arrangement 50 is rotated through 180° so that the side wall surface 56b is illuminated instead.

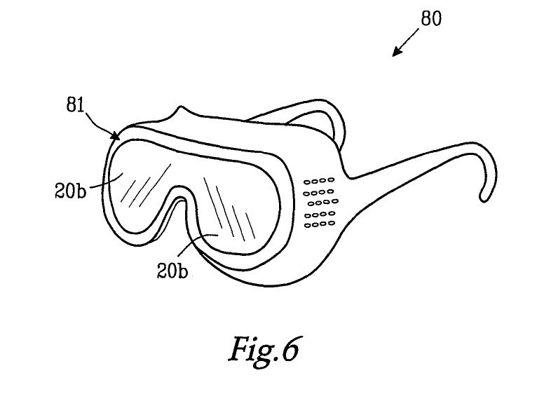

FIG. 6 illustrates a pair of spectacles 80 according to the invention. The spectacles are provided with lenses 81, that can be manufactured of glass, plastic or other material and that act as a bandpass filter 20b for cutting out radiation with certain wavelengths. The spectacles 80 are intended to be used by an operator during inspection of fluorescence, and in particular for visual inspection of an object for detecting cracks. The bandpass filter 20b lets through radiation in a limited wavelength range that includes the wavelength 530 nm. The lower limit for the wavelength range of the bandpass filter 20b is suitably in the range 480-500 nm, and is preferably approximately 490 nm.

With regard to the upper limit, there are several different alternatives. The primary requirement is for UV light and blue light to be cut out by means of the lower limit, while the upper limit can be varied in different ways. If the upper limit for the wavelength range of the bandpass filter 20b is in the range 560-580 nm, preferably approximately 570 nm, false red signals will be able to be cut out. If the upper limit for the wavelength range of the first bandpass filter 20b is instead approximately 700 nm, while it is the case that the red light is not cut out, on the other hand in other respects such a range can make it easier for an operator to carry out the inspection, while at the same time fulfilling the primary objective of cutting out blue light.

It is recognized that the present invention is not limited to the embodiments that are described above and illustrated in the drawings; it is rather the case that an expert in the field will be able to discover that many amendments and modifications can be carried out within the framework of the protection provided in the attached claims.

1. A method for detecting cracks in an object, comprising:
treating an object with a fluorescent agent, illuminating the object; and
recording the fluorescence from the illuminated object by means of an image-recording unit;
digitizing and automatically analyzing an image of the object obtained by means of the image-recording unit with regard to color content in the image, wherein the distribution of the digitized color components of the image in at least one of a given color spectrum and the size of the color components is analyzed in order to detect any cracks in the object.

2. The method as claimed in claim 1, wherein the image is analyzed with regard to the relative size of the color components in the image.

3. The method as claimed in claim 1, wherein the image is analyzed with regard to the absolute size of the color components in the image.

4. The method as claimed in claim 1, wherein the image is analyzed by means of an image-processing method in which the color content in the image is represented in the HSL color space.

5. The method as claimed in claim 4, wherein the image is analyzed with regard to hue (H) represented in the HSL color space.

6. The method as claimed in claim 4, wherein the image is analyzed with regard to color saturation space.

7. The method as claimed in claim 4, wherein the image is analyzed with regard to intensity (L) represented in the HSL color space.

8. The method as claimed in claim 1, wherein the image is analyzed by means of an image-processing method in which the intensity component is separated from the hue component.

9. The method as claimed in claim 1, wherein the image is analyzed by means of color seeking.

10. The method as claimed in claim 1, wherein the image is analyzed by means of color threshold setting.

11. The method as claimed in claim 1, wherein the image is analyzed by comparison with a reference that is based on the spectral signature of the expected fluorescence originating from the fluorescent agent.

12. The method as claimed in claim 11, wherein the reference is created by recording fluorescence from the fluorescent agent by means of the image-recording unit.

13. The method as claimed in claim 12, wherein the reference is created by recording fluorescence from the fluorescent agent applied on the object by means of the image-recording unit.

14. The method as claimed in claim 1, wherein the image is analyzed in real time.

15. The method as claimed in claim 1, wherein the object is illuminated with ultraviolet radiation and in that fluorescence from the object illuminated with ultraviolet radiation is recorded by means of the image-recording unit.

16. A device for detecting cracks in an object, comprising a source of illumination for illuminating an object and an image-recording unit for recording fluorescence from the illuminated object, wherein the device comprises a first bandpass filter arranged in the image-recording unit, which bandpass filter lets through radiation in a limited wavelength range that includes a wavelength that lies within the wavelength range in which the object emits fluorescence.

17. The device as claimed in claim 16, wherein the wavelength range of the first bandpass filter includes the wavelength 530 nm.

18. The device as claimed in claim 16, wherein the wavelength range of the first bandpass filter is substantially centered around the wavelength 530 nm.

19. The device as claimed in claim 16, wherein the wavelength range of the first bandpass filter substantially corresponds to the wavelength range in which the object emits fluorescence.

20. The device as claimed in claim 16, wherein the wavelength range of the first bandpass filter lies outside the wavelength range in which the source of illumination emits radiation.

21. The device as claimed in claim 16, wherein an upper limit for the wavelength range of the first bandpass filter is in the range 560-600 nm.

22. The device as claimed in claim 16, wherein an upper limit for the wavelength range of the first bandpass filter is approximately 570 nm.

23. The device as claimed in claim 16, wherein a lower limit wavelength range of the first bandpass filter is in the range 470-500 nm.

24. The device as claimed in claim 16, wherein a lower limit for the wavelength range of the first bandpass filter is approximately 490 nm.

25. The device as claimed in claim 16, wherein the device comprises a second bandpass filter arranged in the source of illumination, which bandpass filter lets through radiation in a limited wavelength range that includes ultraviolet radiation.

26. The device as claimed in claim 25, wherein the wavelength range of the second bandpass filter lies outside the wavelength range in which the object emits fluorescence.

27. The device as claimed in claim 25, wherein the wavelength range of the second bandpass filter includes the wavelength 365 nm.

28. The device as claimed in claim 25, wherein the wavelength range of the second bandpass filter is substantially centered around the wavelength 365 nm.

29. The device as claimed in claim 25, wherein an upper limit for the wavelength range of the second bandpass filter is in the range 380-410 nm.

30. The device as claimed in claim 25, wherein an upper limit for the wavelength range of the second bandpass filter is approximately 400 nm.

31. The device as claimed in claim 25, wherein an upper limit for the wavelength range of the second bandpass filter is in the range 440-470 nm.

32. The device as claimed in claim 25, wherein an upper limit for the wavelength range of the second bandpass filter is approximately 450 nm.

33. The device as claimed in claim 25, wherein a lower limit for the wavelength range of the second bandpass filter is in the range 310-330 nm.

34. The device as claimed in claim 25, wherein a lower limit for the wavelength range of the second bandpass filter is approximately 320 nm.

35. The device as claimed in claim 25, wherein the source of illumination comprises an optical conductor connected to a source of radiation and in that the second bandpass filter is arranged after the optical conductor in relation to the main direction of the radiation from the source of radiation.

36. The device as claimed in claim 16, wherein the image-recording unit is a camera.

37. The device as claimed in claim 16, wherein the image-recording unit is a color video camera.

38. The device as claimed in claim 16, wherein the source of illumination is arranged to generate mainly ultraviolet radiation for illumination of the object.

39. An arrangement for detecting cracks in an object, comprising a source of illumination for illuminating an object and an image-recording unit for recording fluorescence from the illuminated object, wherein the arrangement has a device for deflecting radiation, which deflecting device comprises a reflector created in a double prism which acts as a beam splitter.

40. The arrangement as claimed in claim 39, wherein the deflecting device comprises a reflector for deflecting at least a significant quantity of the radiation from the source of illumination for illuminating a concealed surface in the object.

41. The arrangement as claimed in claim 39, wherein the arrangement comprises a reflector for deflecting at least a quantity of fluorescence emitted from a concealed surface in the object to the image-recording unit that is sufficient for analysis.

42. The use of an arrangement as claimed in claim 39 for detecting a crack in a groove that has a bottom surface and at least one side wall surface.

43. The use of an arrangement as claimed in claim 39 for detecting a crack in a groove that has a bottom surface and two side wall surfaces.

44. The use of an arrangement as claimed in claim 39 for detecting a crack in a groove that has a bottom surface and two side wall surfaces, in which the side wall surfaces are substantially parallel and extend substantially at right angles in relation to a plane of the bottom surface.

45. The use as claimed claim 42 for detecting a crack in a the side wall surface in the groove.

46. Crack detecting spectacles for use by an operator during inspection of fluorescence for detecting cracks in an illuminated object which has been treated with a fluorescent agent, wherein the spectacles comprise a bandpass filter, which bandpass filter lets through radiation in a limited wavelength range that includes the wavelength 530 nm.

47. The spectacles as claimed in claim 46, wherein an upper limit for the wavelength range of the bandpass filter is in the range 560-600 nm.

48. The spectacles as claimed in claim 46, wherein an upper limit for the wavelength range of the first bandpass filter is approximately 570 nm.

49. The spectacles as claimed in claim 46, wherein an upper limit for the wavelength range of the first bandpass filter is approximately 700 nm.

50. The spectacles as claimed in claim 46, wherein a lower limit for the wavelength range of the first bandpass filter is in the range 470-500 nm.

51. The spectacles as claimed in claim 46, wherein a lower limit for the wavelength range of the first bandpass filter is approximately 490 nm.

52. The use of spectacles as claimed in claim 46 for cutting out blue light during inspection of fluorescence.

53. (canceled)
